(19) United States
(12) Patent Application Publication
(10) Pub. No.: US 2024/0185274 A1
(43) Pub. Date: Jun. 6, 2024

(54) TECHNIQUES FOR IDENTIFYING OPTIMAL EV CHARGING STATION LOCATIONS

(71) Applicant: Recentive Analytics, Inc., Boston, MA (US)

(72) Inventors: Andysheh Tabrizi, Boston, MA (US); Keeon Tabrizi, San Francisco, CA (US)

(21) Appl. No.: 18/463,456

(22) Filed: Sep. 8, 2023

Related U.S. Application Data
(63) Continuation-in-part of application No. 18/073,189, filed on Dec. 1, 2022, now Pat. No. 11,775,872.

(51) Int. Cl. G06Q 30/0202

(52) U.S. Cl. CPC G06Q 30/0202; B60L 53/62

(57) ABSTRACT

A computer-implemented method of projecting a utility load demand including providing vehicle parameters for a plurality of areas and location parameters associated with the plurality of areas to a machine learning (ML) model, iteratively training the ML model to identify relationships between the vehicle parameters, the location parameters, and historical utility data associated with the plurality of areas, receiving a target area and a future target date, providing the target area and the future target date to the trained ML model, obtaining and providing target vehicle parameters and target location parameters for the target area to the trained ML model, determining, via the trained ML model, an EV charging forecast for the target area at the future target date and projecting, via the trained ML model, a utility load demand within the target area at the future target date based on the EV charging forecast.

### CROSS-REFERENCE TO RELATED APPLICATIONS

This application is a continuation-in-part of U.S. patent application Ser. No. 18/073,189, titled “TECHNIQUES FOR IDENTIFYING OPTIMAL EV CHARGING STATION LOCATIONS” and filed on Dec. 1, 2022, the entirety of which is incorporated herein by reference.

### TECHNICAL FIELD OF THE INVENTION

In general, the subject matter of this disclosure relates to techniques for identifying locations for electric vehicle (EV) charging stations, more specifically, for identifying optimal locations for EV charging stations within a specific geographic region.

### BACKGROUND

The use and ownership of electric vehicles (EVs) continues to increase amongst consumers, businesses, and public transportation services. In some cases, EV owners may charge their vehicles at home (e.g., via private chargers). Likewise, EVs that are part of a business fleet may be charged at a private service center. However, many EV owners and operators rely on public charging stations for regular charging and supplemental charging when traveling long distances. Determining where to install these EV charging stations can be difficult due to a wide variety of factors that may need to be considered (e.g., quantity of EVs within an area, available installation locations, potential operating costs, etc.). Failure to properly consider such factors can lead to sub-optimal EV charger stations that draw low usage and/or result in low revenue for EV charger station operators. In addition, such failures may limit the rate of EV adoption amongst consumers, businesses, and public transportation services.

As such, there is a need for improved systems and methods for identifying optimal locations for EV charging stations within specific geographic regions.

### SUMMARY OF THE INVENTION

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims.

At least one aspect of the present disclosure is directed to a computer-implemented method of dynamically generating a charger map for electric vehicle (EV) charger locations. The method includes providing one or more consumer parameters for a plurality of target areas and one or more location parameters associated with the plurality of target areas to a machine learning (ML) model, where the ML model is at least one of a neural network ML model and a support vector ML model, iteratively training the ML model to identify relationships between the one or more consumer parameters and the one or more location parameters using historical data corresponding to the plurality of target areas, where such iterative training improves the accuracy of the ML model, receiving one or more target consumer parameters for a user-specific target area and one or more target location parameters for the user-specific target area, receiving one or more user-specific weights representing one or more prioritized charging features associated with the user-specific target area, providing the one or more target consumer parameters, the one or more target location parameters, and the one or more user-specific weights to the trained ML model, generating, via the trained ML model, a charger map for the user-specific target area including one or more locations for EV chargers within the user-specific target area, the charger map being optimized relative to the one or more prioritized charging features, detecting a real-time change to the one or more target location parameters, providing the real-time change to the trained ML model to improve the accuracy of the trained ML model, and updating, via the trained ML model, the charger map such that the charger map remains optimized relative to the one or more prioritized charging features in view of the real-time change to the one or more target location parameters.

Another aspect of the present disclosure is directed to a system for dynamically generating a charger map for electric vehicle (EV) charger locations. The system includes at least one memory for storing computer-executable instructions and at least one processor for executing the instructions stored on the memory. Execution of the instructions programs the at least one processor to perform operations that include providing one or more consumer parameters for a plurality of target areas and one or more location parameters associated with the plurality of target areas to a machine learning (ML) model, where the ML model is at least one of a neural network ML model and a support vector ML model, iteratively training the ML model to identify relationships between the one or more consumer parameters and the one or more location parameters using historical data corresponding to the plurality of target areas, where such iterative training improves the accuracy of the ML model, receiving one or more target consumer parameters for a user-specific target area and one or more target location parameters for the user-specific target area, receiving one or more user-specific weights representing one or more prioritized charging features associated with the user-specific target area, providing the one or more target consumer parameters, the one or more target location parameters, and the one or more user-specific weights to the trained ML model, generating, via the trained ML model, a charger map for the user-specific target area including one or more locations for EV chargers within the target area, the charger map being optimized relative to the one or more prioritized charging features, detecting a real-time change to the one or more target location parameters, providing the real-time change to the trained ML model to improve the accuracy of the trained ML model, and updating, via the trained ML model, the charger map such that the charger map remains optimized relative to the one or more prioritized charging features in view of the real-time change to the one or more target location parameters.

Another aspect of the present disclosure is directed to a computer-implemented method of determining a utility load demand based on an electric vehicle (EV) charging forecast. The method includes providing one or more vehicle parameters for a plurality of areas and one or more location parameters associated with the plurality of areas to a machine learning (ML) model, where the ML model is at least one of a neural network ML model and a support vector ML model, iteratively training the ML model to identify relationships between the one or more vehicle parameters, the one or more location parameters, and historical utility data associated with the plurality of areas, where such iterative training improves the accuracy of the ML model, receiving, from a user via a user interface, a target area and a future target date, providing the target area and the future target date to the trained ML model, obtaining one or more target vehicle parameters and one or more target location parameters for the target area, providing the one or more target vehicle parameters and the one or more target location parameters to the trained ML model, determining, via the trained ML model, an EV charging forecast for the target area at the future target date, and projecting, via the trained ML model, a utility load demand within the target area at the future target date based on the EV charging forecast.

Another aspect of the present disclosure is directed to a system includes at least one memory for storing computer-executable instructions and at least one processor for executing the instructions stored on the memory. Execution of the instructions programs the at least one processor to perform operations that include providing one or more vehicle parameters for a plurality of areas and one or more location parameters associated with the plurality of areas to a machine learning (ML) model, where the ML model is at least one of a neural network ML model and a support vector ML model, iteratively training the ML model to identify relationships between the one or more vehicle parameters, the one or more location parameters, and historical utility data associated with the plurality of areas, where such iterative training improves the accuracy of the ML model, receiving, from a user via a user interface, a target area and a future target date, providing the target area and the future target date to the trained ML model, obtaining one or more target vehicle parameters and one or more target location parameters for the target area, providing the one or more target vehicle parameters and the one or more target location parameters to the trained ML model, determining, via the trained ML model, an EV charging forecast for the target area at the future target date, and projecting, via the trained ML model, a utility load demand within the target area at the future target date based on the EV charging forecast.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 illustrates a system for identifying optimal locations for EV charging stations in different geographic regions in accordance with aspects described herein.

FIG. 2 illustrates a method for using the system of FIG. 1 to identify optimal locations for EV charging stations in accordance with aspects described herein.

FIG. 3 illustrates a flow diagram of a method for identifying optimal locations for EV charging stations in accordance with aspects described herein.

FIG. 4 illustrates a flow diagram of a method for updating a charger map in accordance with aspects described herein.

FIG. 5 illustrates an example charger map representing optimized locations for EV charging stations in accordance with aspects described herein.

FIG. 6 illustrates a system for projecting utility load demand in different geographic regions in accordance with aspects described herein.

FIG. 7 illustrates a method for using the system of FIG. 6 to project utility load demand in accordance with aspects described herein.

FIG. 8 illustrates a flow diagram of a method for projecting utility load demand in accordance with aspects described herein.

FIG. 9 illustrates a flow diagram of a method for updating a utility load demand projection in accordance with aspects described herein.

FIG. 10A illustrates an example utility map representing a projected utility load demand in accordance with aspects described herein.

FIG. 10B illustrates a data table representing a projected utility load demand in accordance with aspects described herein.

### DETAILED DESCRIPTION

As discussed above, the use and ownership of electric vehicles (EVs) continues to increase amongst consumers, businesses, and public transportation services. In some cases, EV owners or consumers may charge their vehicles at home (e.g., via private chargers). Likewise, EVs that are operated as part of a business fleet may be charged at a private service center. However, many EV owners and operators rely on public charging stations for regular charging and supplemental charging when traveling long distances. Determining where to install these EV charging stations can be difficult due to a wide variety of factors that may need to be considered (e.g., quantity of EVs within an area, available installation locations, potential operating costs, etc.). Failure to properly consider such factors can lead to sub-optimal EV charger stations that draw low usage and/or result in low revenue for EV charger station operators. In addition, such failures may limit the rate of EV adoption amongst consumers, businesses, and public transportation services.

As such, there is a need for improved systems and methods for identifying optimal locations for EV charging stations within specific geographic regions.

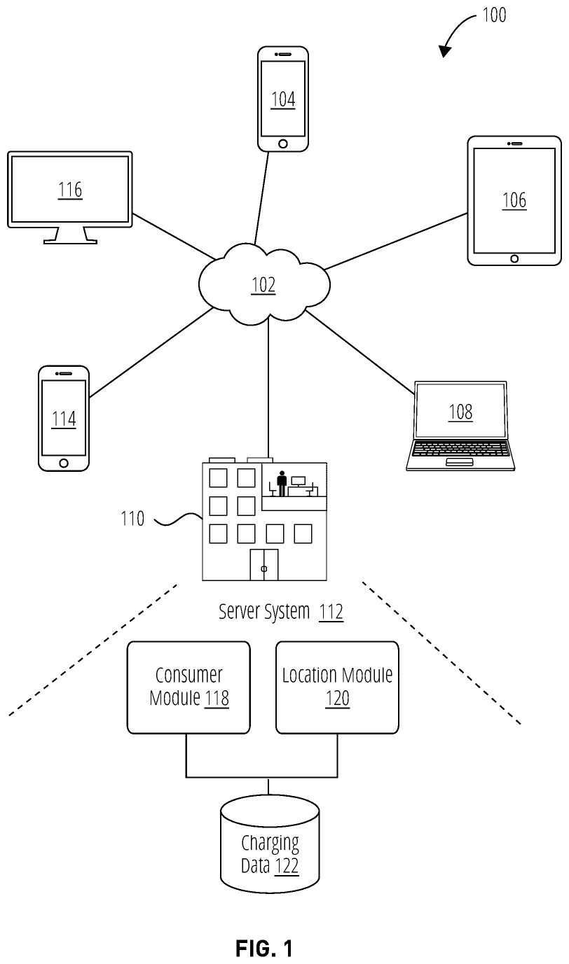

FIG. 1 illustrates an example system 100 for identifying optimal locations for EV charging stations in different geographic regions (e.g., different cities, states, or countries). A server system 112 provides functionality for identifying locations for EV charging stations based on a variety of inputs, as described herein. The server system 112 includes software components and databases that can be deployed at one or more data centers 110 in one or more geographic locations, for example. The server system 112 software components can include, for example, a consumer module 118 and a location module 120. The server system 112 can include subcomponents that can execute on the same or on different individual data processing apparatus. The server system 112 databases can include a charging data 122 database, though it is understood that any number of databases can be included. The databases can reside in one or more physical storage systems. The software components and data will be further described below.

An application, such as, for example, a web-based or other software application can be provided as an end-user application to allow users to interact with the server system 112. The software application or components thereof can be accessed through a network 102 (e.g., the Internet) by users of client devices, such as a smart phone 104, a personal computer 116, a smart cell phone 114, a tablet computer 106, and a laptop computer 108. Other client devices are possible.

The consumer module 118 can include software components that support the software application by, for example, processing and managing data associated with consumers. For example, the consumer module 118 may monitor and forecast consumer behavior within different geographic regions. In one example, the consumer module 118 tracks the number of consumers with EVs. Likewise, the consumer module 118 may track the number of consumers without EVs. In some examples, the consumer module 118 identifies general locations where consumers are concentrated (e.g., neighborhoods, apartment buildings, etc.). The consumer module 118 may receive input parameters associated with consumers (e.g., average income, average distance to work, etc.) and predict the rate of EV adoption within different geographic regions. In some examples, the consumer module 118 may analyze factors that affect the daily travel of consumers, such as accessibility to public transit, highways, etc. In some examples, the consumer module 118 monitors traffic patterns, high-volume transit routes, highway access, and other relevant transit data associated with different geographic regions. The consumer module 118 may be configured to retrieve or otherwise obtain the data discussed above (e.g., from the charging data 122 database or another database). Alternatively, at least a portion of the data may be provided by one or more users.

Similarly, the location module 120 can include software components that support the software application by, for example, processing and managing data associated with potential and existing EV charging station locations. For example, the location module 120 may maintain a record (or map) of available EV charging station locations. Such locations may include land available for sale, businesses who have indicated interest in EV charging stations, government-owned land, etc. In addition, the location module 120 may monitor local zoning restrictions within specific geographic regions. In some examples, the location module 120 is configured to maintain a record (or map) of existing EV charging stations. The location module 120 may be configured to retrieve or otherwise obtain the data discussed above (e.g., from the charging data 122 database or another database). Alternatively, at least a portion of the data may be provided by one or more users.

The charging data 122 can store and provide data for the software application and/or can provide data to or receive data from the consumer module 118 and the location module 120. The data can include, for example, information related to EVs, charging stations, installation costs, operating costs, and local installation contractors. For example, the data can include information related to charging equipment (e.g., Levels 1-3), vehicle compatibility (e.g., trickle charging, fast charging, etc.), equipment availability (e.g., timeframes associated with procurement of EV chargers), contractor availability (e.g., timeframes for completing installation), financial data (e.g., utility costs, local tax rates, insurance, etc.), or any combination thereof.

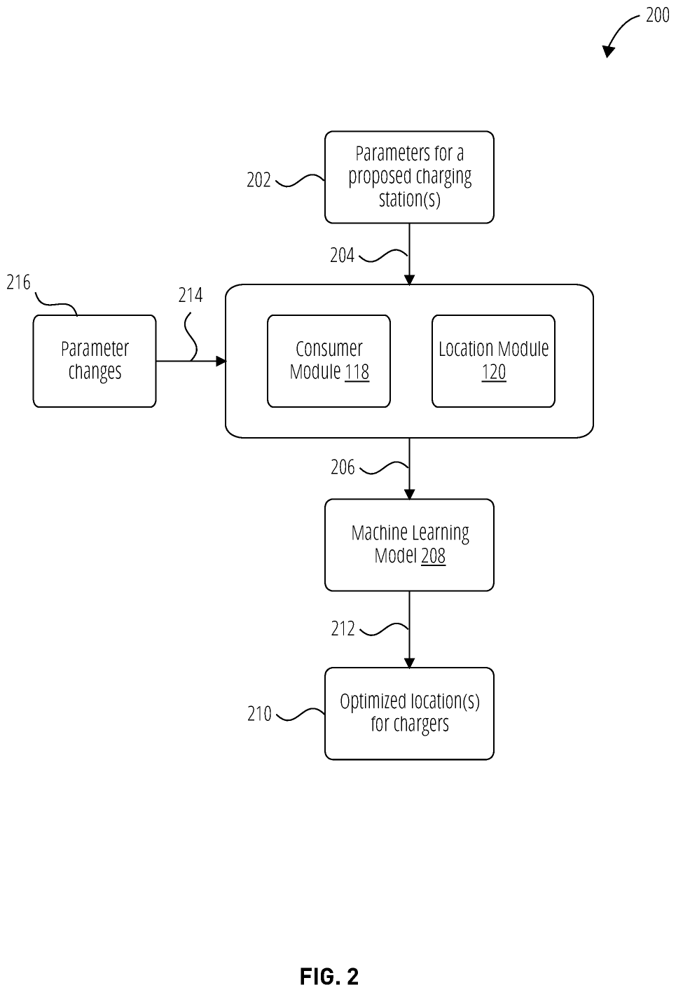

FIG. 2 depicts an example method 200 in which the consumer module 118 and the location module 120 are used to identify optimal locations for EV charging stations (or EV chargers). Parameters 202 for one or more proposed EV charging stations are provided (test 204) as inputs to the consumer module 118 and/or the location module 120. Such input parameters 202 can be, include, or relate to, for example: a geographic region for the proposed EV charging stations (e.g., a target area), a budget for the proposed EV charging stations, a minimum number of EV charging stations, a maximum number of EV charging stations, or any combination thereof. The input parameters 202 can be retrieved from the charging data 122 database, can be manually entered by users, and/or can be retrieved from other sources (e.g., a database or website operated by a third party, such as an EV charging station operator or developer).

The parameters 202 may include one or more charging features to be prioritized when identifying the optimal locations. A user of the software application can specify the charging features that should be considered by the modules 118, 120. Such charging features can include, for example, revenue generated by the EV charging stations, profit generated by the EV charging stations, consumer accessibility (or proximity) to the EV charging stations, usage rates of the EV charging stations, installation costs for the EV charging stations, operational costs for the EV charging stations, maintenance or repair costs for the EV charger map, or any combination thereof. Additionally, or alternatively, each charging feature can be assigned a weight that indicates an importance of the charging feature. For example, a user may choose to weigh revenue for a particular EV charging station more heavily than installation costs.

In the depicted example, the consumer module 118 and the location module 120 use the input parameters 202 to determine and output (step 206) corresponding consumer parameters and location parameters. For example, the consumer module 118 may retrieve and/or compile parameters associated with consumers residing in the user-specified geographic region. In one example, the consumer parameters include information associated with the number of EVs located in the user-specified geographic region. Likewise, the location module 120 may retrieve and/or compile parameters associated with potential and existing EV charging station locations within the user-specified geographic region.

In some examples, the consumer parameters, the location parameters, and the one or more charging features are provided to a machine learning (ML) model or other predictive tool. In one example, a ML model 208 is configured to generate a map 210 that indicates the optimal locations for the proposed EV charging stations (step 212). The map 210 can be or include, for example, locations for the proposed EV charging stations that optimizes, maximizes, or minimizes one or more of the prioritized charging features. For example, the ML model 208 may use the charging feature weights to identify the EV charging station locations based on particular combinations of charging features that may be of interest to the user(s).

In some embodiments, the ML model 208 is included within the consumer module 118 and/or the location module 120. In general, any suitable machine learning technique can be used, such as, for example: a gradient boosted random forest, a regression, a neural network, a decision tree, a support vector machine, a Bayesian network, other type of technique. The ML model 208 can be trained using one or more sets of training data. For example, the ML model 208 may be trained in a first stage using a first set of training data and in a second stage using a second set of training data. The training data can be or include, for example, historical data from different geographical locations or regions. Such data can include information related to the consumer parameters, the location parameters, and the charging features. In general, the ML model 208 can be trained to recognize how to optimize, maximize, or minimize one or more of the charging features based on a given set of input parameters, consumer parameters, and/or location parameters. Once trained, the ML model 208 can receive the input parameters 202, the consumer parameters, and the location parameters as input, generate the optimized map 210 of EV charging station locations, and provide the map 210 as output. To generate the map 210, the ML model 208 can choose a location and charging configuration (e.g., number of chargers, types of chargers, station amenities, etc.) for each EV charging station.

In some examples, after the map 210 has been generated, the consumer module 118 or the location module 120 can receive or detect (step 214) one or more updates or changes 216 to the input parameters 202, the consumer parameters, or the location parameters. These parameter changes 216 can include, for instance, changes to the geographic region, budget, minimum number of EV charging stations, or maximum number of EV charging stations previously provided by the user(s). For example, the user may initially generate the map 210 as part of a bid for developing EV charging stations within the geographic region. However, as part of negotiations, the budget or scope of the development project may change. Likewise, the consumer parameters may change based on the occurrence of one or more events within the geographic region (e.g., a newly announced tax credit for EV purchases, increased gas prices, etc.). Similarly, the location parameters may change as new properties become available for sale, new EV charging stations are installed, etc.

Such a change could result in a new map 210 that is preferred over an original or previous version of the map 210. For example, the new map 210 may achieve a better optimization of one or more of the charging features (e.g., revenue, accessibility, installation costs, etc.). In some embodiments, the consumer module 118 or the location module 120 can search for and/or receive the parameter changes 216 on a regular schedule or at periodic intervals (e.g., every hour, day, week, or month). Alternatively, or additionally, the modules 118, 120 can receive parameter changes 216 when prompted to do so by a user. For instance, the user can use a client device to instruct the modules 118, 120 to retrieve the parameter changes 216 and/or can enter the parameter changes 216 manually. In some examples, the map 210 can be updated based on real-time data (e.g., real-time parameter changes 216) and, in some instances, the map 210 can be dynamically updated in response to changes in this data.

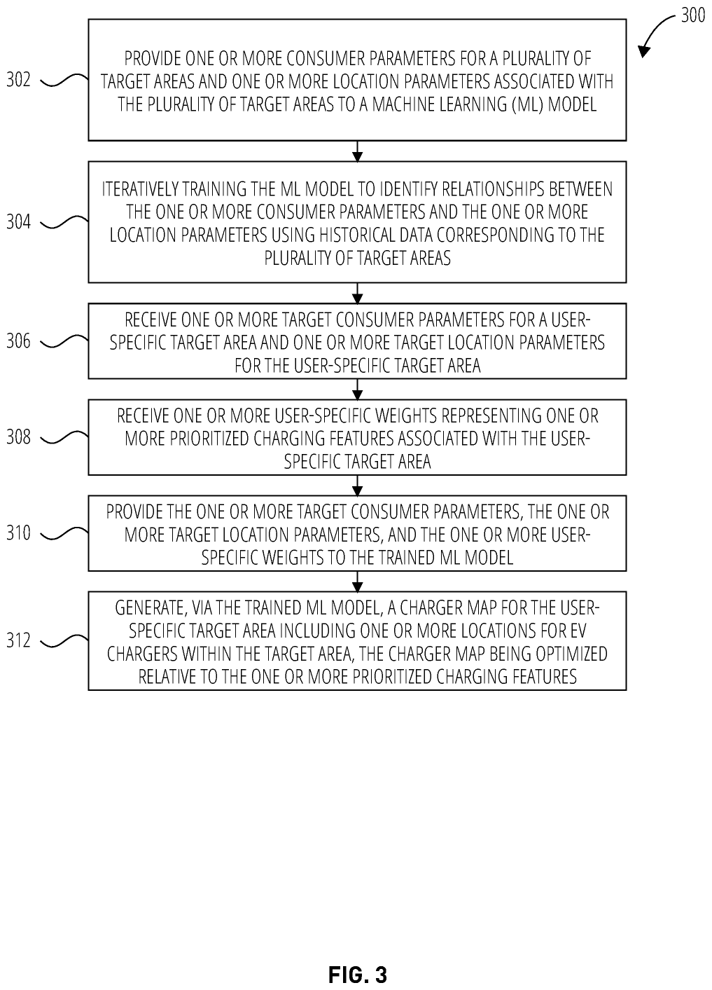

FIG. 3 is flow diagram of a method 300 for identifying optimal locations for EV charging stations in accordance with aspects described herein. In one example, the method 300 is configured to be carried out, at least in part, by the system 100 of FIG. 1.

In block 302, one or more consumer parameters for a plurality of target areas and one or more location parameters associated with the plurality of target areas are provided to a machine learning (ML) model. In one example, the ML model (e.g., ML model 208) is at least one of a neural network ML model and a support vector ML model.

In block 304, the ML model 208 is iteratively trained to identify relationships between the one or more consumer parameters and the one or more location parameters using historical data corresponding to the plurality of target areas. In one example, such iterative training improves the accuracy of the ML model 208.

In block 306, the system 100 receives one or more target consumer parameters for a user-specific target area and one or more target location parameters for the user-specific target area.

In block 308, the system 100 receives one or more user-specific weights representing one or more prioritized charging features associated with the user-specific target area.

In block 310, the consumer module 118 and the location module 120 provides the one or more target consumer parameters, the one or more target location parameters, and the one or more user-specific weights to the trained ML model 208.

In block 312, the system 100 generates, via the trained ML model 208, a charger map for the user-specific target area including one or more locations for EV chargers within the target area. In one example, the charger map (e.g., map 210) is optimized relative to the one or more prioritized charging features.

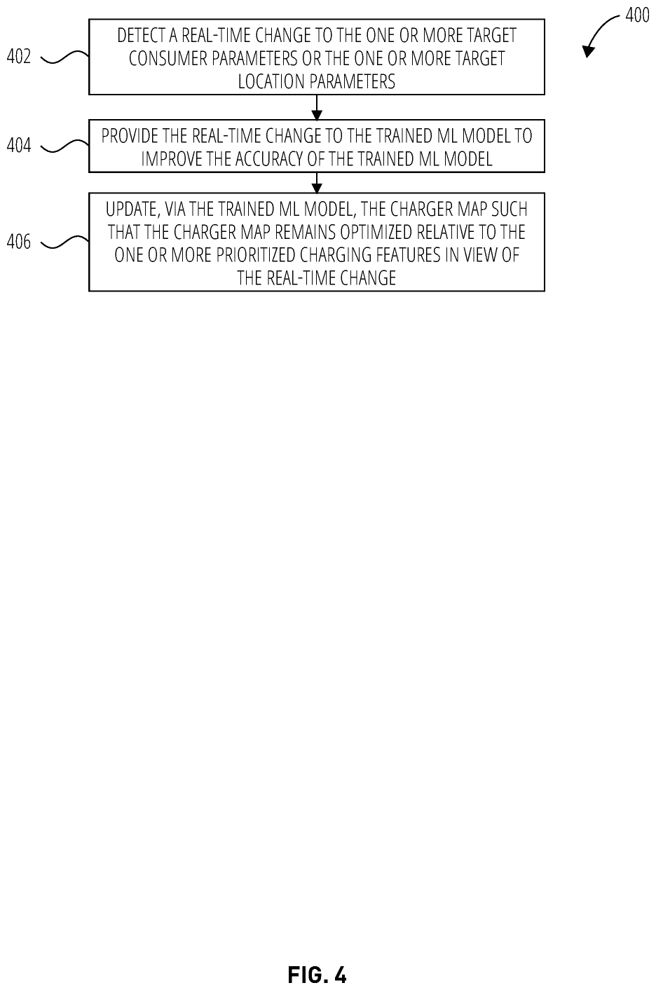

In some examples, the charger map is updated based on real-time changes received or detected by the consumer module 118 or the location module 120. For example, FIG. 4 is flow diagram of a method 400 for updating the charger map. In one example, the method 400 can be performed by the system 100 one or more times following completion of the method 300.

In block 402, the consumer module 118 or the location module 120 detects a real-time change to the target consumer parameters or the target location parameters. In one example, detecting the real-time change includes detecting an EV charger location has been added or removed within the target area. For example, the location module 120 may detect that another charging provider has installed new charging stations within the target area. Likewise, the location module 120 may detect that a potential EV charger location has been added or removed within the target area (e.g., a new plot of land has been listed for sale). The location module 120 may also detect changes to existing and potential EV charger locations. For example, the location module 120 may detect that additional chargers have been added to an existing charging station or that the size of a potential charging location has changed. In some examples, the system 100 detects a real-time change initiated by the user. For example, the user may modify the size of target area or adjust the location of the target area after the charging map has been generated.

In block 404, the consumer module 118 or the location module 120 provides the real-time change to the trained ML model 208 to improve the accuracy of the trained ML model 208.

In block 406, the trained ML model 208 updates the charger map such that the charger map remains optimized relative to the one or more prioritized charging features in view of the real-time change to the one or more target location parameters.

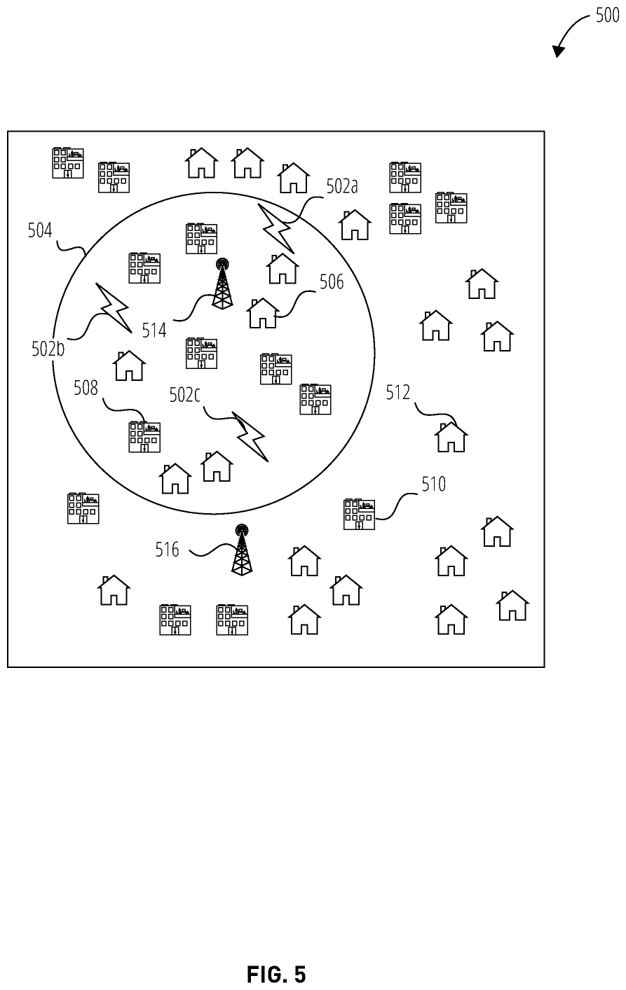

FIG. 5 is an example charger map 500 representing optimized locations for EV charging stations. In one example, the system 100 of FIG. 1 is configured to generate and update the charger map 500 (e.g., via methods 300 and 400). As shown, the charger map 500 includes a plurality of charger locations 502 within a target area 504. In some examples, the target area 504 may be a state, a city, a town, a zip code, or a neighborhood. In other examples, the target area 504 may be a user-defined region. The user-defined region may have an adjustable radius that determines the size of the target area 504.

As described above, the plurality of charger locations 502 in the charger map 500 are optimized relative to the one or more prioritized charging features specified by the user(s). In order to achieve such optimization, the charger locations 502 may be selected based on different factors including: proximity to one or more residential sub-areas 506 (e.g., homes, neighborhoods, apartment complexes, etc.) within the target area 504, proximity to one or more commercial sub-areas 508 (e.g., office buildings, retail shops, movie theaters, airports, etc.) within the target area 504, proximity to one or more commercial sub-areas 510 outside the target area 504, proximity to one or more residential sub-areas 512 outside the target area 504, proximity to one or more consumer resources 514 (e.g., Wi-Fi or cell towers) within the target area 504, proximity to one or more consumer resources 516 outside the target area 504, or any combination thereof. In addition, existing charging stations within the target area 504 and outside the target area 504 may be taken into account when generating the charger map 500.

In one example, the charger map 500 for the target area 504 is optimized to maximize at least one of revenue generated by the charging stations 502 and the usage rates of the charging stations 502. In some examples, the charger map 500 for the target area 504 is optimized to minimize at least one of installation costs and operational costs for the charging stations 502.

A graphical user interface for the charger map 500 can include one or more buttons (not shown) that allow the user(s) to reset the charger map 500, generate an output file with the charger location information, save the charger map 500, or load a different map.

Advantageously, the systems and methods described herein represent and/or achieve a significant improvement in computer functionality. For example, use of the consumer module 118 and the location module 120 (and the associated ML model 208) can improve the accuracy and/or automation of data processing. In various instances, for example, the consumer module 118, the location module 120, and the ML model 208 are developed and trained to receive a wide variety and quantity of data (e.g., the input parameters 202) and to consider a variety of charging features when generating desired or optimized charger maps. Such charger maps can be updated, as needed, when any changes to the input parameters, the consumer parameters, the location parameters, or charging features are received or detected. By training the ML model 208 to generate optimized charging maps automatically and update the charger maps dynamically, in response to real-time changes in data, the input parameters, the consumer parameters, the location parameters, and the charging features can be processed and considered more efficiently and accurately, compared to prior approaches.

While the above embodiments describe identifying optimal locations for EV charging stations, it may also be beneficial to identify (or analyze) the effects of EV chargers on utility systems. For example, as more EVs are put into service, the amount of EV chargers installed in residential and commercial environments will continue to rise. As such, it is possible that utility systems (e.g., power systems, transformers, etc.) may become constrained or stressed while attempting to meet the additional utility demand attributed to EV charging. In some cases, it may be desirable to upgrade, repair, and/or install utility systems in response to the additional utility demand.

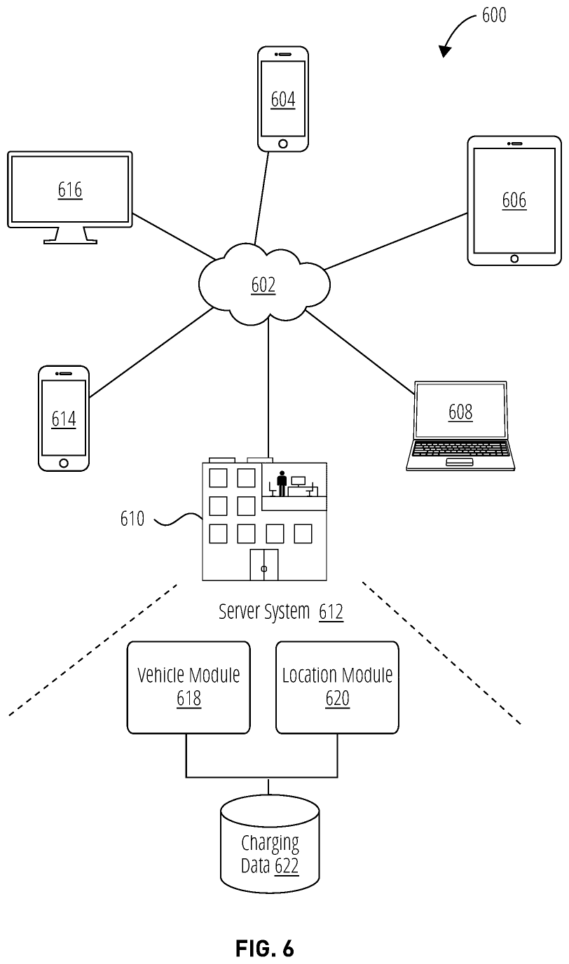

FIG. 6 illustrates an example system 600 for determining a utility load demand in different geographic regions (e.g., different cities, states, or countries) based on an EV charging forecast. In some examples, the system 600 is configured to determine the EV charging forecast for the geographic regions. In some examples, the system 600 may receive (or otherwise obtain) the EV charging forecast from another source (e.g., a database, user, etc.).

A server system 612 provides functionality for determining the utility load demand for different geographic regions based on a variety of inputs, as described herein. The server system 612 includes software components and databases that can be deployed at one or more data centers 610 in one or more geographic locations, for example. The server system 612 software components can include, for example, a vehicle module 618 and a location module 620. The server system 612 can include subcomponents that can execute on the same or on different individual data processing apparatus. The server system 612 databases can include a charging data 622 database, though it is understood that any number of databases can be included. The databases can reside in one or more physical storage systems. The software components and data will be further described below.

An application, such as, for example, a web-based or other software application can be provided as an end-user application to allow users to interact with the server system 612. The software application or components thereof can be accessed through a network 602 (e.g., the Internet) by users of client devices, such as a smart phone 604, a personal computer 616, a smart cell phone 614, a tablet computer 606, and a laptop computer 608. Other client devices are possible.

The vehicle module 618 can include software components that support the software application by, for example, processing and managing data associated with EVs. For example, the vehicle module 618 may monitor and forecast consumer behavior within different geographic regions. In one example, the vehicle module 618 tracks the number of consumers with EVs. Likewise, the vehicle module 618 may track the number of consumers without EVs. In some examples, the vehicle module 618 identifies general locations where consumers (and their vehicles) are concentrated (e.g., neighborhoods, apartment buildings, etc.). The vehicle module 618 may receive input parameters associated with consumers (e.g., average income, average distance to work, etc.) and predict the consumer rate of EV adoption within different geographic regions. In some examples, the vehicle module 618 may receive (or obtain) the predicted rate of EV adoption from another source (e.g., a database). In some examples, the vehicle module 618 may analyze factors that affect the daily travel of consumers, such as accessibility to public transit, highways, etc. In some examples, the vehicle module 618 monitors traffic patterns, high-volume transit routes, highway access, and other relevant transit data associated with different geographic regions. The vehicle module 618 may be configured to retrieve or otherwise obtain the data discussed above (e.g., from the charging data 622 database or another database). Alternatively, at least a portion of the data may be provided by one or more users.

In addition, the vehicle module 618 may monitor and forecast commercial behavior within different geographic regions. In one example, the vehicle module 618 tracks the number of businesses using EVs (or EV fleets). Likewise, the vehicle module 618 may track the number of businesses that have yet to adopt EVs. In some examples, the vehicle module 618 identifies general locations where businesses are concentrated (e.g., office parks, warehouse districts, etc.). The vehicle module 618 may receive input parameters associated with businesses (e.g., average revenue, distance to customers, operational strategies, etc.) and predict the commercial rate of EV adoption within different geographic regions. In some examples, the vehicle module 618 may receive (or obtain) the predicted rate of EV adoption from another source (e.g., a database). In some examples, the vehicle module 618 may analyze factors that affect the daily travel of business vehicles, such as accessibility to highways or alternative forms of transit (e.g., planes, trains, cargo ships, etc.). In some examples, the vehicle module 618 monitors traffic patterns, high-volume transit routes, highway access, and other relevant transit data associated with different geographic regions. The vehicle module 618 may be configured to retrieve or otherwise obtain the data discussed above (e.g., from the charging data 622 database or another database). Alternatively, at least a portion of the data may be provided by one or more users.

Likewise, the vehicle module 618 may monitor and forecast public entity directives within different geographic regions. In one example, the vehicle module 618 tracks the number of public (or government-operated) entities using EVs (or EV fleets). Such public entities may include public transit (e.g., subways, busses, etc.) and public services (e.g., garbage collection, police, firefighters, etc.). Likewise, the vehicle module 618 may track the number of public entities that have yet to adopt EVs. In some examples, the vehicle module 618 identifies general locations where public entities (e.g., hubs, stations, etc.) are concentrated. The vehicle module 618 may receive input parameters associated with public entities (e.g., average funding, operating budget, political climate, proposed legislature, current legislature, public policy initiatives, etc.) and predict the public entity rate of EV adoption within different geographic regions. In some examples, the vehicle module 618 may receive (or obtain) the predicted rate of EV adoption from another source (e.g., a database). In some examples, the vehicle module 618 may analyze factors that affect the daily travel of public vehicles, such as operating hours, weather conditions, etc. In some examples, the vehicle module 618 monitors traffic patterns, high-volume transit routes, highway access, and other relevant transit data associated with different geographic regions. The vehicle module 618 may be configured to retrieve or otherwise obtain the data discussed above (e.g., from the charging data 622 database or another database). Alternatively, at least a portion of the data may be provided by one or more users.

Similarly, the location module 620 can include software components that support the software application by, for example, processing and managing data associated with potential and existing EV charging stations. For example, the location module 620 may maintain a record (or map) of available EV charging stations. Likewise, the location module 620 may maintain a record (or map) of available locations for the installation of EV charging stations. Such locations may include land available for sale, businesses who have indicated interest in EV charging stations, government-owned land, etc. In addition, the location module 620 may monitor local zoning restrictions within specific geographic regions. It should be appreciated that the potential and existing EV charging stations can include residential chargers (e.g., private at-home chargers, community chargers, etc.), public chargers, and private chargers (e.g., for charging business fleets, public transit fleets, etc.).

In addition to EV charging station locations, the location module 620 may processes and manage data associated with utility infrastructures. For example, the location module 620 may maintain a record (or map) of utility systems (e.g., power systems, transformers, etc.). In some examples, the location module 620 is configured to track existing or planned utility system upgrades, repairs, and/or installations. In some examples, the location module 620 may track available locations for utility system installations. Such locations may include land available for sale, utility provider-owned land, government-owned land, etc. In addition, the location module 620 may monitor local zoning restrictions within specific geographic regions. In some examples, the location module 620 is configured to monitor utility (e.g., power) performance in different geographic regions. For example, the location module 620 may analyze utility data to determine typical (or average) load demand within a region, and in some cases, the utility system's ability to meet said demand. The location module 620 may monitor seasonal factors that affect utility load demand, such as weather (e.g., higher A/C usage in the summer) and tourism (e.g., influx of travelers during particular periods of the year). In some examples, the location module 620 may monitor (or assess) the rate of utility failure in specific geographic regions (e.g., due to weather events, aging infrastructure, etc.). The location module 620 may be configured to retrieve or otherwise obtain the data discussed above (e.g., from the charging data 622 database or another database). Alternatively, at least a portion of the data may be provided by one or more users.

The charging data 622 can store and provide data for the software application and/or can provide data to or receive data from the vehicle module 618 and the location module 620. The data can include, for example, information related to EVs, charging stations, utility requirements of EVs for charging, and utility requirements of EV chargers for operating. For example, the data can include information related to charging equipment (e.g., Levels 1-3), vehicle compatibility (e.g., trickle charging, fast charging, etc.), equipment availability (e.g., timeframes associated with procurement of EV chargers), contractor availability (e.g., timeframes for completing installation), financial data (e.g., utility costs, local tax rates, insurance, etc.), or any combination thereof.

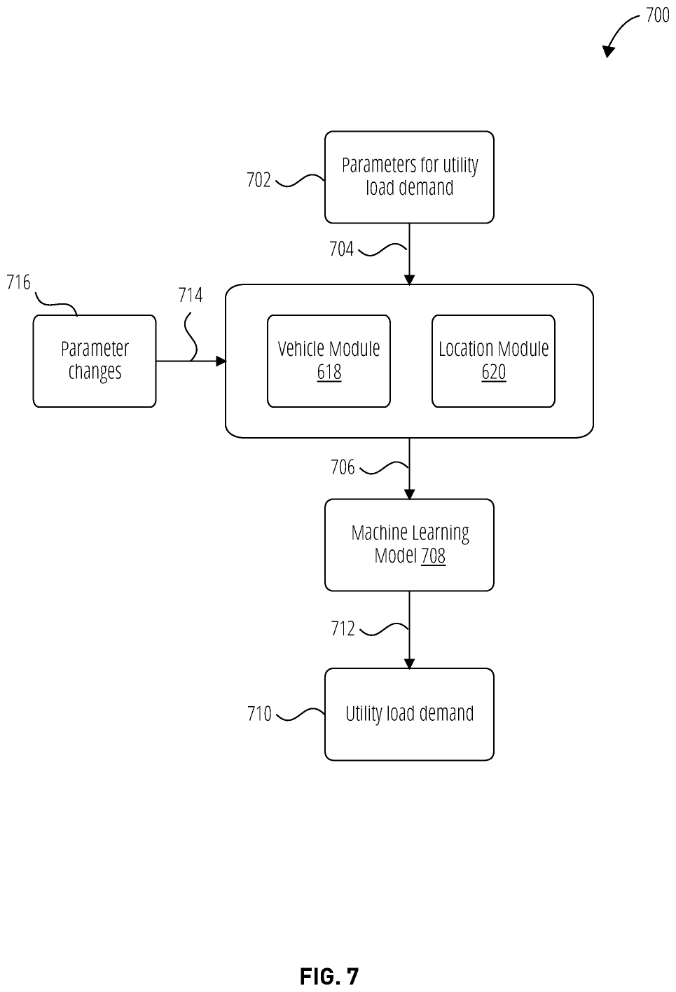

FIG. 7 depicts an example method 700 in which the vehicle module 618 and the location module 620 are used to project utility load demand based on an EV charging forecast. Parameters 702 for the utility load demand are provided (step 704) as inputs to the vehicle module 618 and/or the location module 620. Such input parameters 702 can be, include, or relate to, for example: a geographic region for the utility load demand (e.g., a target area) and a future timeframe for the utility load demand (e.g., a future target date). In one example, the target area is a state, a city, a town, a zip code, a neighborhood, or any other suitable region. In some examples, the target area may be a user defined area. For example, the target area may correspond to a portion of a city (e.g., serviced by a particular utility provider). In some examples, the future target date corresponds to a date in the future for which the utility load demand is being projected. For example, the future target date may be a specific day, a specific year, or a period of time (e.g., two years from today, five years from today, etc.).

In the depicted example, the vehicle module 618 and the location module 620 use the input parameters 702 to determine and output (step 706) corresponding vehicle parameters and location parameters. For example, the vehicle module 618 may retrieve and/or compile parameters associated with vehicles operating in the user-specified geographic region. In one example, the vehicle parameters include information associated with the number of EVs located in the user-specified geographic region (e.g., existing and projected). Likewise, the location module 620 may retrieve and/or compile parameters associated with potential and existing EV charging station locations within the user-specified geographic region. In some examples, the location module 620 may retrieve and/or compile parameters associated with utility information for the user-specified geographic region (e.g., present day utility load demand, typical utility performance, etc.).

In some examples, the vehicle parameters and the location parameters are provided to an ML model or other predictive tool. In one example, a ML model 708 projects a utility load demand 710 for the user-specified geographic region at the user-specified future date (step 712). In some examples, the ML model 708 is configured to project the utility load demand 710 based on an EV charging forecast for the target area. The EV charging forecast may represent the number and types of EV chargers that are expected to be installed (or otherwise active) within the target area by the future target date. The EV charging forecast may include private residential chargers (e.g., personal at-home chargers), public chargers, private commercial chargers (e.g., for employees or business fleets), government-operated chargers (e.g., for government vehicles or public transit), and any other type of EV charger that may be located within the target area. In some examples, the ML model 708 is configured to determine the EV charging forecast based on the vehicle parameters and the location parameters for the target area. As described above, the vehicle parameters include one or more rates of EV adoption within the target area. For example, such rates may include rates of adoption for consumers, commercial business, and government operated entities within the target area. The ML model 708 may use the rate(s) of EV adoption to scale the EV charging forecast based on factors such as population growth, businesses growth, or any other suitable characteristic of the target area. In some examples, the EV charging forecast may account for political initiatives within the target area. Such initiatives may include programs that incentivize the purchase of EVs through tax-credits (or discounts) or bans on the sale of non-EVs (e.g., combustion engine vehicles). In some examples, the rate(s) of EV adoption may be provided to the ML model 708 from another source (e.g., users, consulting agencies, etc.).

The ML model 708 is configured to use the EV charging forecast to project the corresponding utility load demand at the future target date. In some examples, the EV charging forecast includes the anticipated locations and types of EV chargers that will be active at the future target date. As such, the ML model 708 may determine the utility load demand by accounting for the features and requirements of the various EV chargers. For example, a residential charger that is typically used to slow charge overnight may have a different power demand profile compared to rapid chargers positioned at highway exits. In addition, the ML model 708 may account for factors that offset the increased utility load demand attributed to EV chargers. For example, the ML model 708 may account for political initiatives that incentive renewable (or alternative) power usage. The ML model 708 may account for a rate of residential solar power adoption within the target area that contributes to reduced power demand from utility providers.

In some examples, the ML model 708 generates a map indicating the utility load demand in different sections of the region. For example, the map may be similar to a heat map, in that red sections indicate high utility load demand, yellow sections indicate medium (or average) utility load demand, and green sections indicate low utility load demand. Likewise, the ML model 708 may generate a map indicating utility performance in different sections of the region relative to the capabilities of the current utility infrastructure. For example, red sections indicate areas where the existing infrastructure is incapable of meeting the projected utility load demand, yellow sections indicate areas where the existing infrastructure is stressed (or constrained) by the projected utility load demand, and green sections indicate areas where the existing infrastructure is capable of meeting the projected utility load demand. In some examples, the ML model 708 is configured to account for regular upgrades and improvements when assessing the projected utility load demand relative to existing utility infrastructure. In some examples, the map may show the delta between what the current infrastructure can support and the projected utility load demand. In some examples, the ML model 708 may assign a score to each section of the target area based on the ability of the utility infrastructure to meet the projected utility load demand.

In some examples, the ML model 708 may generate a map that shows the maximum, average, and/or minimum projected utility load demand at distinct locations within the region. For example, the map may include a grid that provides the maximum, average, and/or minimum utility load demand at a desired resolution (e.g., every 0.1 square mile, every 0.5 square mile, etc.). Similarly, the map may show the maximum, average, and/or minimum utility load demand at specific addresses within the geographic region (e.g., the addresses of customers serviced by a particular utility provider). While the above examples describe the generation of utility maps, it should be appreciated that the ML model 708 may represent the utility load demand 710 in other formats (e.g., a data table, a database, etc.). In some examples, the utility load demand 710 may be packaged in a data format that is deliverable to utility service providers (or other companies associated with utilities). In some examples, the utility load demand 710 includes a plurality of projections. For example, the utility load demand 710 may provide projections for various times of the day (e.g., daytime, nighttime, etc.), different days of the week (e.g., weekdays, weekends, etc.), and/or different times of the year (e.g., winter, summer, etc.).

In some embodiments, the ML model 708 is included within the vehicle module 618 and/or the location module 620. In general, any suitable machine learning technique can be used, such as, for example: a gradient boosted random forest, a regression, a neural network, a decision tree, a support vector machine, a Bayesian network, other type of technique. The ML model 708 can be trained using one or more sets of training data. For example, the ML model 708 may be trained in a first stage using a first set of training data and in a second stage using a second set of training data. The training data can be or include, for example, historical data from different geographical locations or regions. Such data can include information related to the vehicle parameters, the location parameters, and the historical utility data. In some examples, the historical utility data includes past utility load demands and/or utility performance within the different geographical locations or regions. In general, the ML model 708 can be trained to recognize how to identify relationships between the vehicle parameters, the location parameters, and the historical utility data. Once trained, the ML model 708 can receive the input parameters 702, the vehicle parameters, and the location parameters as input, and provide the projected utility load demand 710 as output.

In some examples, after the utility load demand 710 has been generated, the vehicle module 618 or the location module 620 can receive or detect (step 714) one or more updates or changes 716 to the input parameters 702, the vehicle parameters, or the location parameters. These parameter changes 716 can include, for instance, changes to the target area, future target date, the rate(s) of EV adoption within the target area, additions of EV chargers within the target area, and changes to the utility infrastructure within the target area. For example, the user may initially generate the utility load demand 710 as part of a bid for developing utility systems within the geographic region. However, as part of negotiations, the scope of the development project may change. Likewise, the vehicle parameters may change based on the occurrence of one or more events within the geographic region (e.g., a newly announced tax credit for EV purchases, increased gas prices, etc.). Similarly, the location parameters may change as new EV charging stations are installed, residential developments are announced, etc.

Such a change could result in a new utility load demand 710 that is more accurate compared to the original or previous version of the utility load demand 710. For example, the new utility load demand 710 may indicate additional utility improvements needed. In some embodiments, the vehicle module 618 or the location module 620 can search for and/or receive the parameter changes 716 on a regular schedule or at periodic intervals (e.g., every hour, day, week, or month). Alternatively, or additionally, the modules 118, 120 can receive parameter changes 716 when prompted to do so by a user. For instance, the user can use a client device to instruct the modules 118, 120 to retrieve the parameter changes 716 and/or can enter the parameter changes 716 manually. In some examples, the utility load demand 710 can be updated based on real-time data (e.g., real-time parameter changes 716) and, in some instances, the utility load demand 710 can be dynamically updated in response to changes in this data.

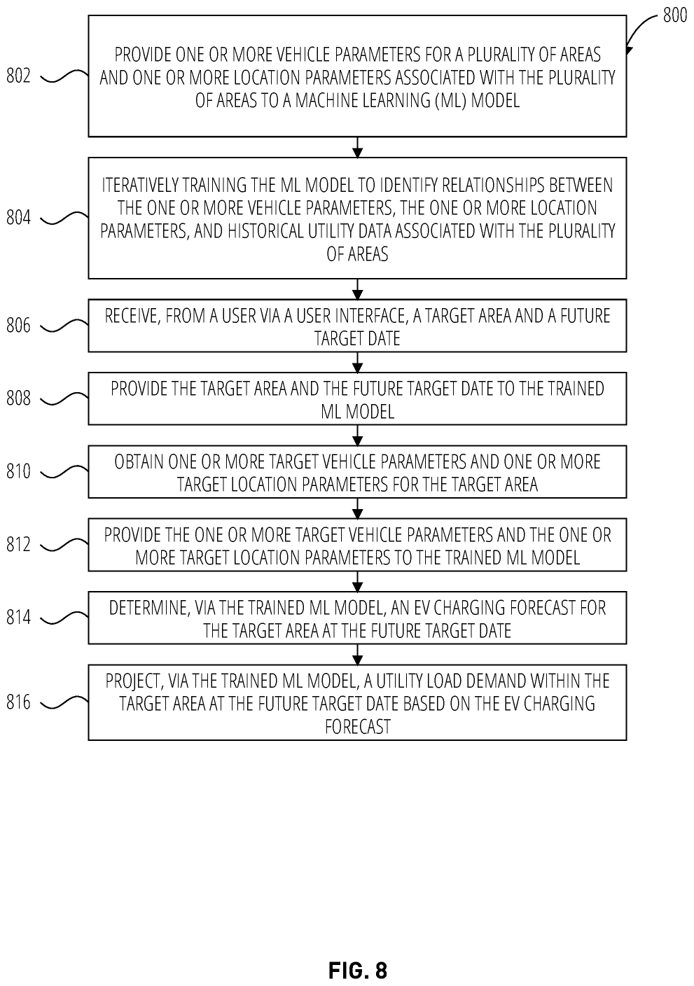

FIG. 8 is flow diagram of a method 800 for project utility load demand in accordance with aspects described herein. In one example, the method 800 is configured to be carried out, at least in part, by the system 600 of FIG. 6.

In block 802, one or more vehicle parameters for a plurality of areas and one or more location parameters associated with the plurality of areas are provided to a machine learning (ML) model. In one example, the ML model (e.g., ML model 708) is at least one of a neural network ML model and a support vector ML model.

In block 804, the ML model 708 is iteratively trained to identify relationships between the one or more vehicle parameters, the one or more location parameters, and historical utility data associated with the plurality of areas. In one example, such iterative training improves the accuracy of the ML model 708.

In block 806, the system 600 receives a target area and a future target date. In some examples, the system 600 is configured to receive the target area and the future target date from a user (e.g., via a user interface).

In block 808, the system 600 provides the target area and the future target date to the trained ML model.

In block 810, the system 600 obtains one or more target vehicle parameters and one or more target location parameters for the target area. In some examples, the vehicle module 618 is configured to obtain the target vehicle parameters and the location module 620 is configured to obtain the target location parameters. In some examples, at least a portion of the one or more target vehicle parameters and/or the one or more target location parameters are retrieved from at least one database (e.g., the charging data 622 database). In some examples, at least a portion of the one or more target vehicle parameters and/or the one or more target location parameters are received from a user (e.g., via a user interface). In some examples, the one or more vehicle parameters includes a rate of consumer, commercial, and/or government EV adoption within the target area. In some examples, the one or more target vehicle parameters include information associated with a number of EVs located in the target area. In some examples, the one or more target location parameters include information associated with potential EV charger locations within the target area.

In block 812, the vehicle module 618 and the location module 620 provide the one or more target vehicle parameters and the one or more target location parameters to the trained ML model.

In block 814, the trained ML model 708 determines an EV charging forecast for the target area at the future target date. In some examples, the ML model 708 is configured to determine the EV charging forecast using the target vehicle parameters and the target location parameters.

In block 816, the trained ML model projects a utility load demand within the target area at the future target date based on the EV charging forecast.

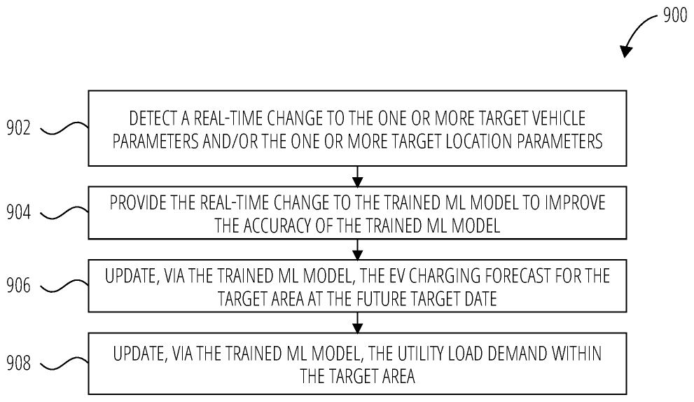

In some examples, the projected utility load demand is updated based on real-time changes received or detected by the vehicle module 618 or the location module 620. For example, FIG. 9 is flow diagram of a method 900 for updating the utility load demand. In one example, the method 900 can be performed by the system 600 one or more times following completion of the method 800.

In block 902, the vehicle module 618 or the location module 620 detects a real-time change to the one or more target vehicle parameters and/or the one or more target location parameters. In one example, detecting the real-time change includes detecting an EV charger location has been added or removed within the target area. For example, the location module 620 may detect that a homeowner has installed a private charger or that a public charging station has been installed. Likewise, the location module 120 may detect that a potential EV charger location has been added or removed within the target area (e.g., a new plot of land has been listed for sale, an apartment building with a parking garage is being developed, etc.). The location module 120 may also detect changes to existing and potential EV charger locations. For example, the location module 120 may detect that additional chargers have been added to an existing charging station or that the size of a potential charging location has changed. In some examples, the system 600 detects a real-time change initiated by the user. For example, the user may modify the size of target area, change the future target date, or adjust the location of the target area after the charging map has been generated.

In block 904, the vehicle module 618 or the location module 620 provides the real-time change to the trained ML model 708 to improve the accuracy of the trained ML model 708.

In block 906, the trained ML model 708 updates the EV charging forecast for the target area at the future target date.

In block 908, the trained ML model updates the utility load demand within the target area based on the updated EV charging forecast.

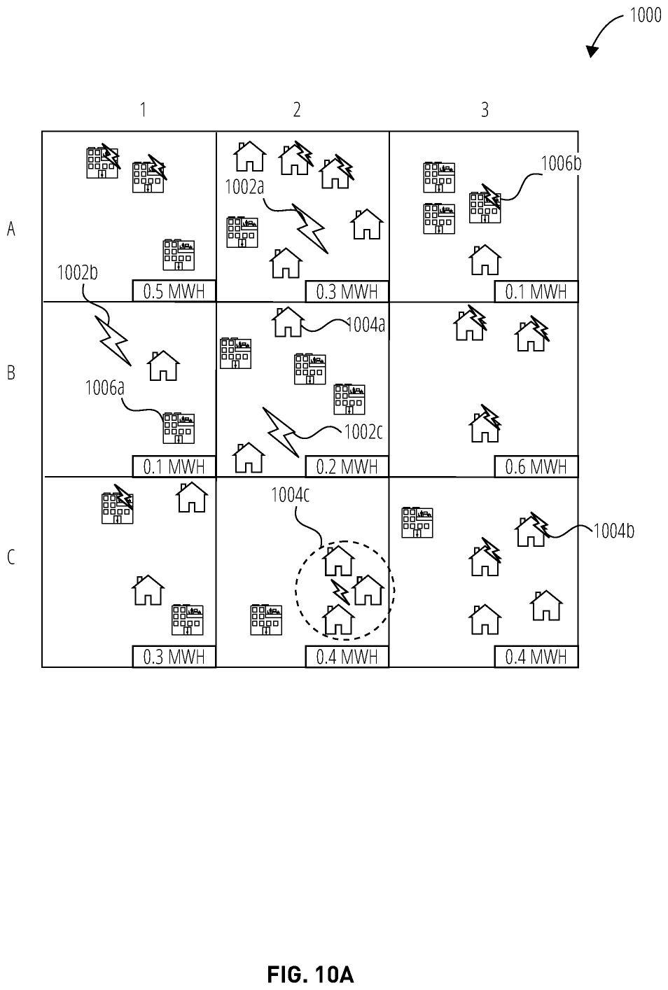

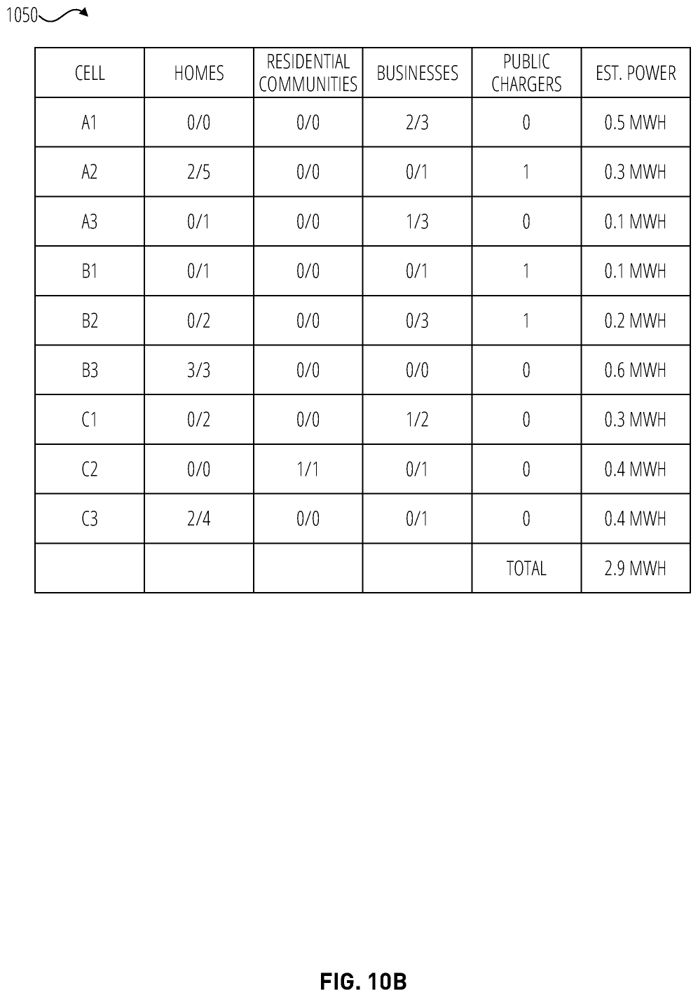

FIG. 10A is an example utility map 1000 representing a projected utility load demand. In one example, the system 600 of FIG. 6 is configured to generate and update the utility map 1000 (e.g., via methods method 800 and 900). As shown, the utility map 1000 includes a grid that breaks the target area down into smaller sections (e.g., A1, B2, etc.). In the illustrated example, the utility map 1000 includes public EV chargers 1002, non-EV enabled homes 1004a, EV enabled homes 1004b, EV enabled residential communities 1004c, non-EV enabled businesses 1006a, and EV enabled businesses 1006b. Each grid section includes an estimated daily power demand for the section. For example, the estimated daily power demand for section A1 is 0.5 megawatt hours (MWh). As described above, the utility load demand for the target area is projected based on the EV charging forecast for the target area. As such, the utility load demand (or the estimated daily power demand) for each grid section corresponds to the EV charging forecast for each section. In other words, the existing EV chargers and the EV chargers expected to be added by the future target date combine to produce the estimated daily power demand for the grid section. For example, two out of the three businesses in section A1 are forecasted to be EV enabled businesses 1006b (e.g., having on-site chargers for fleet charging or employee charging), resulting in the estimated daily power demand of 0.5 MWh. Similarly, the grid section A2 has a public charger 1002a and two out of the five homes are forecasted to be EV enabled homes 1004b (e.g., having private home chargers), resulting in the estimated daily power demand of 0.3 MWh. Likewise, the grid section C2 is forecasted to have an EV enabled residential community 1004c (e.g., an apartment complex with EV chargers for residents), resulting in the estimated daily power demand of 0.4 MWh. In some examples, providing estimated daily power demand projections for each grid section allows the utility provider to assess (or prioritize) where the most critical upgrades are needed. In some cases, the system 600 may generate an alert in response to an estimate that exceeds a threshold. For example, the threshold may be predetermined (e.g., by a user, by the utility provider) or dynamically determined based on the underlying utility infrastructure in each grid section.

In some examples, a graphical user interface for the utility map 1000 can include one or more buttons (not shown) that allow the user(s) to reset the utility map 1000, generate an output file with the projected utility information, save the utility map 1000, or load a different map.

The system 600 may provide the projected utility load demand in a number of different formats. For example, FIG. 10B illustrates an example data table 1050 representing a projected utility load demand. In one example, the data table 1050 corresponds to the utility map 1000 of FIG. 10A. In some examples, the data in the data table 1050 is derived from the utility map 1000. In some examples, the data table 1050 is used to generate the utility map 1000. In some examples, the system 600 is configured to generate the data table 1050 without the utility map 1000.

As shown in FIG. 10B, the data table 1050 includes columns that correspond to various infrastructure features of the target area. For example, the column titled “Homes” includes a forecasted ratio of EV enabled homes to total homes for each grid section of the utility map 1000. Likewise, the column titled “Businesses” includes a forecasted ratio of EV enabled businesses to total businesses for each grid section. In addition to listing the estimated daily power demand for each grid section, the data table 1050 may include a total estimated daily power demand for the target area. It should be appreciated that the data table 1050 may be configured to include different types of data. For example, the data table 1050 may include maximum projections, average projections, minimum projections, deltas between projected demand and current utility infrastructure capabilities, or projections of any other suitable utility demand or performance metric. It should also be understood that the types of infrastructure features included in the utility map 1000 and/or the data table 1050 are provided as examples and are not intended to limit the types of infrastructure features that may contribute to utility load demand projections or EV charging forecasts.

Advantageously, the use of the vehicle module 618 and the location module 620 (and the associated ML model 708) can improve the accuracy and/or automation of data processing. In various instances, for example, the vehicle module 618, the location module 620, and the ML model 708 are developed and trained to receive a wide variety and quantity of data (e.g., the input parameters 702) and to consider a variety of charging and utility features when projecting the utility load demand (or determining the EV charging forecast). Such utility load demand projections can be updated, as needed, when any changes to the input parameters, the vehicle parameters, the location parameters, the charging features, or the utility features are received or detected. By training the ML model 708 to project the utility load demand (and determine the EV charging forecast) automatically and update the utility load demand dynamically, in response to real-time changes in data, the input parameters, the vehicle parameters, the location parameters, the charging features, and the utility features can be processed and considered more efficiently and accurately, compared to prior approaches.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid-state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation.

Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-implemented method of determining a utility load demand based on an electric vehicle (EV) charging forecast, the method comprising:
providing one or more vehicle parameters for a plurality of areas and one or more location parameters associated with the plurality of areas to a machine learning (ML) model, wherein the ML model is at least one of a neural network ML model and a support vector ML model;
iteratively training the ML model to identify relationships between the one or more vehicle parameters, the one or more location parameters, and historical utility data associated with the plurality of areas, wherein such iterative training improves the accuracy of the ML model;
receiving, from a user via a user interface, a target area and a future target date;
providing the target area and the future target date to the trained ML model;
obtaining one or more target vehicle parameters and one or more target location parameters for the target area;
providing the one or more target vehicle parameters and the one or more target location parameters to the trained ML model;
determining, via the trained ML model, an EV charging forecast for the target area at the future target date; and
projecting, via the trained ML model, a utility load demand within the target area at the future target date based on the EV charging forecast.

2. The method of claim 1, wherein obtaining the one or more target vehicle parameters and the one or more target location parameters for the target area includes retrieving at least a portion of the one or more target vehicle parameters and the one or more target location parameters from at least one database.

3. The method of claim 1, wherein obtaining the one or more target vehicle parameters and the one or more target location parameters for the target area includes receiving, via the user interface, at least a portion of the one or more target vehicle parameters and the one or more target location parameters.

4. The method of claim 1, wherein the one or more vehicle parameters includes a rate of consumer EV adoption within the target area.

5. The method of claim 1, wherein the one or more vehicle parameters includes a rate of commercial EV adoption within the target area.

6. The method of claim 1, further comprising:
detecting a real-time change to the one or more target vehicle parameters and/or the one or more target location parameters;
providing the real-time change to the trained ML model to improve the accuracy of the trained ML model;
updating, via the trained ML model, the EV charging forecast for the target area at the future target date; and
updating, via the trained ML model, the utility load demand within the target area.

7. The method of claim 6, wherein detecting the real-time change to the one or more target location parameters includes detecting an EV charger location has been added or removed within the target area.

8. The method of claim 6, wherein detecting the real-time change to the one or more target location parameters includes detecting a potential EV charger location has been added or moved within the target area.

9. The method of claim 1, wherein the target area is one of a state, a city, a town, a zip code, or a neighborhood.

10. The method of claim 1, wherein the target area is a user-defined region.

11. The method of claim 10, further comprising:
detecting, via the user interface, a real-time change to the target area;
providing the real-time change to the trained ML model to improve the accuracy of the trained ML model;
updating, via the trained ML model, the EV charging forecast for the target area at the future target date; and
updating, via the trained ML model, the utility load demand within the target area.

12. The method of claim 1, wherein the one or more target vehicle parameters include information associated with a number of EVs located in the target area.

13. The method of claim 1, wherein the one or more target location parameters include information associated with potential EV charger locations within the target area.

14. The method of claim 1, wherein the one or more target location parameters include information associated with existing EV charger locations within the target area.

15. A system comprising:
at least one memory for storing computer-executable instructions; and
at least one processor for executing the instructions stored on the memory, wherein execution of the instructions programs the at least one processor to perform operations comprising:
providing one or more vehicle parameters for a plurality of areas and one or more location parameters associated with the plurality of areas to a machine learning (ML) model, wherein the ML model is at least one of a neural network ML model and a support vector ML model;
iteratively training the ML model to identify relationships between the one or more vehicle parameters, the one or more location parameters, and historical utility data associated with the plurality of areas, wherein such iterative training improves the accuracy of the ML model;
receiving, from a user via a user interface, a target area and a future target date;
providing the target area and the future target date to the trained ML model;
obtaining one or more target vehicle parameters and one or more target location parameters for the target area;
providing the one or more target vehicle parameters and the one or more target location parameters to the trained ML model;
determining, via the trained ML model, an EV charging forecast for the target area at the future target date; and
projecting, via the trained ML model, a utility load demand within the target area at the future target date based on the EV charging forecast.

16. The system of claim 15, wherein obtaining the one or more target vehicle parameters and the one or more target location parameters for the target area includes retrieving at least a portion of the one or more target vehicle parameters and the one or more target location parameters from at least one database.

17. The system of claim 15, wherein obtaining the one or more target vehicle parameters and the one or more target location parameters for the target area includes receiving, via the user interface, at least a portion of the one or more target vehicle parameters and the one or more target location parameters.

18. The system of claim 15, wherein the one or more vehicle parameters includes a rate of consumer EV adoption within the target area.

19. The system of claim 15, wherein the one or more vehicle parameters includes a rate of commercial EV adoption within the target area.

20. The system of claim 15, wherein execution of the instructions programs the at least one processor to perform operations further comprising:
detecting a real-time change to the one or more target vehicle parameters and/or the one or more target location parameters;
providing the real-time change to the trained ML model to improve the accuracy of the trained ML model;
updating, via the trained ML model, the EV charging forecast for the target area at the future target date; and
updating, via the trained ML model, the utility load demand within the target area.

21. The system of claim 20, wherein detecting the real-time change to the one or more target location parameters includes detecting an EV charger location has been added or removed within the target area.

22. The system of claim 20, wherein detecting the real-time change to the one or more target location parameters includes detecting a potential EV charger location has been added or moved within the target area.

23. The system of claim 15, wherein the target area is one of a state, a city, a town, a zip code, or a neighborhood.

24. The system of claim 15, wherein the target area is a user-defined region.

25. The system of claim 24, wherein execution of the instructions programs the at least one processor to perform operations further comprising:
detecting, via the user interface, a real-time change to the target area;
providing the real-time change to the trained ML model to improve the accuracy of the trained ML model;
updating, via the trained ML model, the EV charging forecast for the target area at the future target date; and
updating, via the trained ML model, the utility load demand within the target area.

26. The system of claim 15, wherein the one or more target vehicle parameters include information associated with a number of EVs located in the target area.

27. The system of claim 15, wherein the one or more target location parameters include information associated with potential EV charger locations within the target area.

28. The system of claim 15, wherein the one or more target location parameters include information associated with existing EV charger locations within the target area.
